(19) United States
(12) Patent Application Publication
(10) Pub. No.: US 2022/0261765 A1
(43) Pub. Date: Aug. 18, 2022

(54) SYSTEMS AND METHODS TO GAUGE CANDIDATES TO BE A SUCCESSFUL REMOTE EMPLOYEE

(71) Applicant: Skuad Pte. Ltd., Singapore (SG)

(72) Inventors: Sundeep Sahi, Chandigarh (IN); Naman Singhal, Faridabad (IN); Pranav Chaturvedi, Gurgaon (IN); David Fall, Towaco, NJ (US); Rohit Singh, Indirapuram (IN)

(21) Appl. No.: 17/674,969

(22) Filed: Feb. 18, 2022

(30) Foreign Application Priority Data
Feb. 18, 2021 (IN) 202141006796

(51) Int. Cl. G06Q 10/10; G06F 16/903; G06F 16/9032; G06Q 50/00

(52) U.S. Cl. CPC G06Q 10/1053; G06Q 50/01; G06F 16/90328; G06F 16/90344

(57) ABSTRACT

The current disclosure relates to a system and method for assessing a candidate for identifying a successful remote employee based on a textual interaction between a recruiter and the candidate over a mobile messaging platform. The method includes a step of receiving, by a computation machine, text strings from computing devices of the candidate and the recruiter. The computation machine includes processors and an objective function module. The method includes a step of processing one or more text strings for determining a probability that the candidate matches the query string using the computation machine. The method includes a step of generating, by the objective function module, an output score by determining a probability that the text strings match an employment requirement data stored in a memory. The objective function module identifies the successful remote employee based on the output score.

### RELATED APPLICATION

This application claims the benefit of, and priority to IN provisional application No. 202141006796, filed on Feb. 18, 2021, the entirety of this application is hereby incorporated herein by reference.

### TECHNICAL FIELD

The presented disclosure is generally directed towards automated remote employee selection. More particularly, but not limited to, a system and method to gauge candidates to be successful remote employee.

### BACKGROUND

Currently, it is extremely difficult to find suitable remote employees to meet critical business objectives. Recruiters work with hiring managers to hire a qualified and successful candidate.

Existing solutions for finding and assessing remote employees are highly fragmented, costly, and time-consuming to manage, often including web postings, advertisements, employee referrals, engaging recruiters, and searching resume bulletin boards.

### SUMMARY

Systems and methods for assessing a candidate for identifying a successful remote employee based on a textual interaction between a recruiter and the candidate over a mobile messaging platform are provided, as shown in and/or described in connection with at least one of the figures.

One aspect of the present disclosure relates to a method for assessing a candidate for identifying a successful remote employee based on a textual interaction between a recruiter and the candidate over a mobile messaging platform. The method includes a step of receiving, by a computation machine, one or more text strings from one or more computing devices of the candidate and the recruiter. The computation machine includes one or more processors and an objective function module. The method includes a step of processing, by the one or more processors, the one or more text strings for determining a probability that the candidate matches the query string using the computation machine. The method includes a step of generating, by the objective function module, an output score by determining a probability that the text strings are matching with an employment requirement data stored in a memory. The objective function module identifies the successful remote employee based on the (e.g., binary) output score.

In an aspect, the computation machine is configured to apply a semantic network to predict a closeness of the matching between the text strings and the employment requirement data.

In an aspect, the semantic network measures one or more characteristics of the successful remote employee that is revealed in the candidate's tone in the mobile messaging platform.

In an aspect, the objective function module is a function in the computation machine that generates the (e.g., binary) output score(s) based on the text strings that correspond to the probability of a match between the text strings and the employment requirement data.

In an aspect, the computation machine is configured to apply a neural network to predict the closeness of the match between the text strings and the employment requirement data.

In an aspect, the recruiter executes a search in a social network platform for communications that includes one or more key terms by using one or more computing devices.

In an aspect, the semantic network is a knowledge base that represents semantic relations between one or more concepts.

An aspect of the present disclosure relates to a system to assess a candidate to identify a successful remote employee based on a textual interaction between a recruiter and the candidate over a mobile messaging platform. The system includes a computation machine to receive one or more text strings from one or more computing devices of the candidate and the recruiter. The computation machine includes one or more processors; and an objective function module. The one or more processors process the one or more text strings to determine a probability that the candidate matches the query string using the computation machine. The objective function module generates a (e.g., binary) output score by determining a probability that the text strings are matching with employment requirement data stored in a memory. The objective function module identifies the successful remote employee based on the (e.g., binary) output score.

In an aspect, the computation machine is configured to apply a semantic network to predict a closeness of the matching between the text strings and the employment requirement data.

In an aspect, the semantic network measures one or more characteristics of the successful remote employee that is revealed in the candidate's tone in the mobile messaging platform.

In an aspect, the objective function module is a function in the computation machine that generates the (e.g., binary) output score(s) based on the text strings that correspond to the probability of a match between the text strings and the employment requirement data.

In an aspect, the computation machine is configured to apply a neural network to predict the closeness of the match between the text strings and the employment requirement data.

In an aspect, the recruiter executes a search in a social network platform for communications that includes one or more key terms by using one or more computing devices.

In an aspect, the semantic network is a knowledge base that represents semantic relations between one or more concepts.

An aspect of the present disclosure relates to a non-transitory computer-readable storage medium storing executable instructions for assessing a candidate for identifying a successful remote employee based on a textual interaction between a recruiter and the candidate over a mobile messaging platform that, as a result of being executed by a memory and one or more processors of a computation machine, cause the computation machine to at least: receive, by the computation machine, one or more text strings from one or more computing devices of the candidate and the recruiter; process, by the one or more processors, the one or more text strings to determine a probability that the candidate matches the query string using computation machine; generate, by an objective function module, an (e.g., binary) output score by determining a probability that the text strings are matching with an employment requirement data stored in the memory, wherein the objective function module identifies the successful remote employee based on the (e.g., binary) output score.

In an aspect, the computation machine is configured to apply a semantic network to predict a closeness of the matching between the text strings and the employment requirement data.

In an aspect, the semantic network measures one or more characteristics of the successful remote employee that is revealed in the candidate's tone in the mobile messaging platform.

In an aspect, the objective function module is a function in the computation machine that generates the (e.g., binary) output score(s) based on the text strings that correspond to the probability of a match between the text strings and the employment requirement data.

In an aspect, the computation machine is configured to apply a neural network to predict the closeness of the match between the text strings and the employment requirement data.

In an aspect, the recruiter executes a search in a social network platform for communications that includes one or more key terms by using the one or more computing devices.

Other embodiments and advantages will become readily apparent to those skilled in the art upon viewing the drawings and reading the detailed description hereafter, all without departing from the spirit and the scope of the disclosure. The drawings and detailed descriptions presented are to be regarded as illustrative in nature and not in any way as restrictive.

Other features of the example embodiments will be apparent from the drawings and from the detailed description that follows.

### BRIEF DESCRIPTION OF THE DRAWINGS

The accompanying drawings illustrate the embodiments of systems, methods, and other aspects of the disclosure. Any person with ordinary skills in the art will appreciate that the illustrated element boundaries (e.g., boxes, groups of boxes, or other shapes) in the figures represent an example of the boundaries. In some examples, one element may be designed as multiple elements, or multiple elements may be designed as one element. In some examples, an element shown as an internal component of one element may be implemented as an external component in another and vice versa. Furthermore, the elements may not be drawn to scale.

Various embodiments will hereinafter be described in accordance with the appended drawings, which are provided to illustrate, not limit, the scope, wherein similar designations denote similar elements, and in which:

FIG. 1 illustrates a network implementation of the present system, in accordance with one embodiment of the present disclosure.

FIG. 2 illustrates a block diagram of the present system for assessing a candidate for identifying a successful remote employee based on a textual interaction between a recruiter and the candidate over a mobile messaging platform, in accordance with one embodiment of the present disclosure.

FIG. 3 illustrates a block diagram for electronically analyzing a plurality of text strings texted by the candidate via the mobile messaging platform, in accordance with one embodiment of the present disclosure.

FIG. 4 illustrates a block diagram of the semantic network measuring the characteristic(s) of a successful remote employee that is revealed in the candidate's tone in the mobile messaging platform, in accordance with one embodiment of the present disclosure.

FIG. 5 illustrates a flowchart of the method for assessing a candidate for identifying a successful remote employee based on a textual interaction between a recruiter and the candidate over a mobile messaging platform, in accordance with an alternative embodiment of the present disclosure.

### DETAILED DESCRIPTION

The disclosure is best understood with reference to the detailed figures and description set forth herein. Various embodiments of the present system and method have been discussed with reference to the figures. However, those skilled in the art will readily appreciate that the detailed description provided herein with respect to the figures are merely for explanatory purposes, as the present system and method may extend beyond the described embodiments. For instance, the teachings presented and the needs of a particular application may yield multiple alternative and suitable approaches to implement the functionality of any detail of the present systems and methods described herein. Therefore, any approach to implement the present system and method may extend beyond certain implementation choices in the following embodiments.

According to an embodiment herein, the methods of the present disclosure may be implemented by performing or completing manually, automatically, and/or a combination of thereof. The term “method” refers to manners, means, techniques, and procedures for accomplishing any task including, but not limited to, those manners, means, techniques, and procedures either known to the person skilled in the art or readily developed from existing manners, means, techniques and procedures by practitioners of the art to which the present disclosure belongs. The persons skilled in the art will envision many other possible variations within the scope of the present system and method described herein.

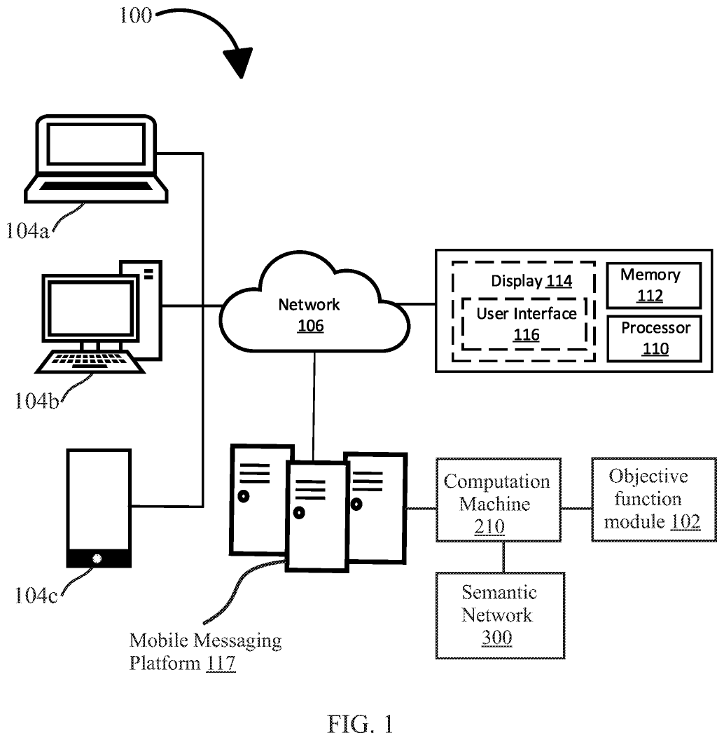

The present disclosure provides a system and method that use interaction(s) between the recruiter and the candidate via the mobile messaging platform to gauge or assess the ability of the candidate to be a successful remote employee. FIG. 1 illustrates a network implementation of the present system 100, in accordance with one embodiment of the present disclosure. The system 100 includes a computation machine 210 to receive one or more text strings from one or more computing devices 104 (for example, a laptop 104a, a desktop 104b, and a smartphone 104c) of the candidate and the recruiter. Other examples of the computing devices 104, may include but are not limited to a phablet and a tablet. The computation machine 210 includes one or more processors 110; and an objective function module 102. The one or more processors 110 process the one or more text strings to determine a probability of a match between the text strings and employment requirement data. The objective function module 102 generates an (e.g., binary) output score by determining the probability of the match between the text strings and the employment requirement data stored in a memory 112. The memory 112 is communicatively coupled to the processor 110, wherein the memory 112 stores instructions executed by the processor 110. The memory 112 may be a non-volatile memory or a volatile memory. Examples of nonvolatile memory may include, but are not limited to flash memory, a Read Only Memory (ROM), a Programmable ROM (PROM), Erasable PROM (EPROM), and Electrically EPROM (EEPROM) memory. Examples of volatile memory may include but are not limited to Dynamic Random-Access Memory (DRAM), and Static Random-Access memory (SRAM).

The processor 110 may include at least one data processor for executing program components for executing user- or system-generated requests. Processor 110 may include specialized processing units such as integrated system (bus) controllers, memory management control units, floating-point units, graphics processing units, digital signal processing units, etc. Processor 110 may include a microprocessor, such as AMD® ATHLON® microprocessor, DURON® microprocessor OR OPTERON® microprocessor, ARM's application, embedded or secure processors, IBM® POWERPC®, INTEL′S CORE® processor, ITANIUM® processor, XEON® processor, CELERON® processor or other line of processors, etc. Processor 110 may be implemented using a mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 110 may be disposed of in communication with one or more input/output (I/O) devices via an I/O interface. I/O interface may employ communication protocols/methods such as, without limitation, audio, analog, digital, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMAX, or the like), etc.

The objective function module 102 identifies the successful remote employee based on the (e.g., binary) output score. In an embodiment, the objective function module 102 is a function in the computation machine 210 that generates the (e.g., binary) output score(s) based on the text strings that correspond to the probability of a match between the text strings and the employment requirement data.

The memory 112 may store various program modules, application programs, and so forth that may include computer-executable instructions that upon execution by the processor 110 may cause various operations to be performed. The memory 112 stores program modules such as the objective function module 102 that functions in the form of logic and rules that respectively support and enable the enrollment, verification, authorization, and access functions described above with reference to FIGS. 1-3.

In an embodiment, the computation machine 210 is configured to apply a semantic network 300 to predict a closeness of the matching between the text strings and the employment requirement data. In an embodiment, the semantic network 210 measures one or more characteristics of the successful remote employee that is revealed in the candidate's tone in the mobile messaging platform 117. In an embodiment, the semantic network 300 is a knowledge base that represents semantic relations between one or more concepts.

In an embodiment, the computation machine 210 is configured to apply a neural network to predict the closeness of the match between the text strings and the employment requirement data. In an embodiment, the recruiter executes a search in a social network platform for communications that includes one or more key terms by using the one or more computing devices 104a, 104b, and 104c.

According to an embodiment herein, the one or more computing devices 104a, 104b, and 104c, the mobile messaging platform 117, and the computation machine 210 are communicatively connected over a network 106 to transmit and receive data related to the textual interaction. Network 106 may be a wired or a wireless network, and the examples may include but are not limited to the Internet, Wireless Local Area Network (WLAN), Wi-Fi, Long Term Evolution (LTE), Worldwide Interoperability for Microwave Access (WiMAX), and General Packet Radio Service (GPRS).

In accordance with one preferred embodiment, computing devices communicate via network 106, e.g., a local area network (LAN) a wide area network (WAN), or the Internet. In addition, one or more computing devices can be arranged as a LAN or a WAN. In the preferred embodiment, the network is the Internet and each of the individual computing devices is configured to establish connectivity with the Internet using conventional application programs and conventional data communication protocols. For example, each computing device preferably includes a web browser application such as Google Chrome or Firefox, and each computing device may be connected to the Internet via an Internet service provider (ISP). In a practical embodiment, computing devices are connected to networks through various communication links. As used herein, a “communication link” may refer to the medium or channel of communication, in addition to the protocol used to carry out communication over the link. In general, a communication link may include, but is not limited to, a telephone line, a modem connection, an Internet connection, an Integrated Services Digital Network (ISDN) connection, an Asynchronous Transfer Mode (ATM) connection, a frame relay connection, an Ethernet connection, a coaxial connection, a fiber-optic connection, satellite connections (e.g., Digital Satellite Services), wireless connections, radio frequency (RF) connections, electromagnetic links, two-way paging connections, and combinations thereof

Communication links may be suitably configured in accordance with the particular communication technologies and/or data transmission protocols associated with the given computing device. For example, a communication link may utilize broadband data transmission techniques, the TCP/IP suite of protocols, the wireless application protocol (WAP), hypertext markup language (HTML), extensible markup language (XML), or a combination thereof. Communication links may be established for continuous communication and data updating or for intermittent communication, depending upon the infrastructure.

As mentioned above, system 100 preferably communicates with one or more databases. Database is preferably configured to communicate with servers in accordance with known techniques such as the TCP/IP suite of protocols. In a practical embodiment, the database may be realized as a conventional SQL database, e.g., an ORACLE-based database.

The computation machine 210 may further include a display 114 having a User Interface (UI) 116 that may be used by the user or the administrator to initiate a request to view the textual interaction between the recruiter and the candidate and provide various inputs to the computation machine 210. Display 114 may further be used to display details related to the candidate. The functionality of the computation machine 210 may alternatively be configured within each of the plurality of computing devices 104. In an embodiment, the hiring manager repeats this practice daily, weekly, monthly, or at any schedule and at any time of day that the candidate is working.

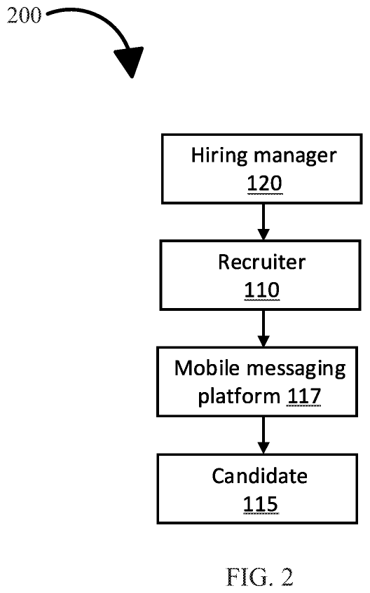

FIG. 2 illustrates a block diagram 200 of the present system for assessing a candidate 115 for identifying a successful remote employee based on a textual interaction between a recruiter 110 and the candidate over a mobile messaging platform 117, in accordance with one embodiment of the present disclosure. Typically, a successful remote employee has one or several of the characteristic(s) described below, such as 1) organization, 2) self-disciplined, 3) focused, 4) resourceful, 5) intrinsically motivated, 6) assertive, 7) prioritized, 8) independent, and/or 9) calm. The present systems and methods may use interaction(s) between the recruiter 110 and the candidate 115 via the mobile messaging platform 117 (e.g., WhatsApp, Facebook Messenger, Slack, etc.) to gauge or assess the ability for a candidate 115 to be a successful remote employee. In one embodiment, the mobile messaging platform 117 may use a bot, an AI bot, or an automated messaging service to connect with candidate 115. The systems and methods assess a potential hire based on one or multiple interactions with a recruiter in a text conversation (e.g., via some type of chat interface, text messages, email messages, etc.). The mobile messaging platform 117 communication(s) hereinafter may be called a chat session/communication or social media communication.

In another embodiment, the serial steps of FIG. 2 can happen in any order. The steps from hiring manager 120 to recruiter 110 to mobile messaging platform 117 to candidate 115 can occur in parallel in this embodiment. The order shown can be changed to any other order.

As an example, the recruiter 110 may: 1) help write job descriptions (e.g., it is up to a hiring manager 120 whether they want help writing the job description(s)), 2) discuss everything with the hiring manager (e.g., like what hard and/or soft skills the hiring manager 120 is looking for), 3) check the candidate's 115 web presence, social media presence, and social media posts (e.g., on Facebook, Twitter, Instagram, LinkedIn, Google, etc.) via the mobile messaging platform 117, 4) check if the candidate 115 understands the business, 5) determine where the candidate 115 will fit in the company if hired, and other similar criteria or characteristic(s). The recruiter 110 and/or the hiring manager 120 may also pose one or several questions to candidate 115. These questions can be used for one or a plurality of criteria or score(s) described below.

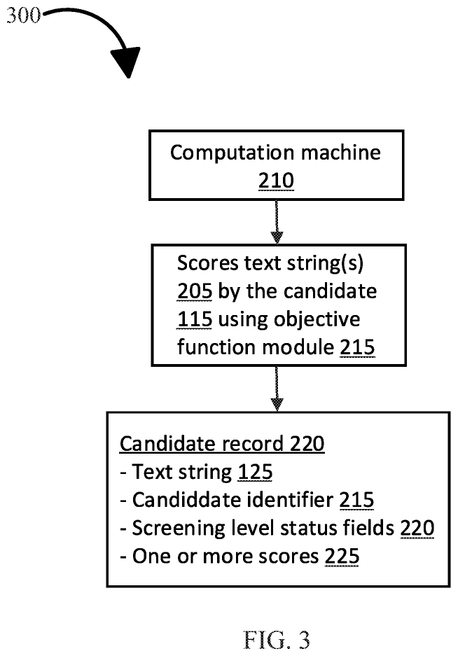

FIG. 3 is a block diagram for electronically analyzing a plurality of text strings 205 texted by the candidate 115 via the mobile messaging platform 117. In an embodiment, the computation machine 210 (e.g., computer or processor) may score the text string 205 using an objective function module 215. The objective function module is a function or equation in the computation machine 210 that can generate score(s) based on the text string(s) 205 that correspond to the likelihood of a match between the text string 205 and an employment requirement.

The objective function module 215 may generate the (e.g., binary) output score 225 (also referred to as output score, score, and supplemental score(s)) that corresponds to the likelihood of a match between the text string 205 and an employment requirement. Based on the score 225, candidate 115 may be invited to participate in an electronic dialog, such as a chat session with a recruiter 110 via the mobile messaging platform 117 (described above). The computation machine 210 may be used to generate supplemental score(s) 225 based on the chat session or subsequent chat sessions. The score(s) 225 may be used to evaluate the likelihood of the match and/or to assess whether candidate 115 can be a successful remote employee.

In more detail and in one embodiment, the text string 125 may be used to formulate a candidate record 220. The candidate record 220 may include the text string 125, a candidate identifier 230, one or more screening level status fields 240, one or more scores 225, and any other suitable information. The screening level status field 240 may be used to record information about the level of screening to which candidate 115 has been subjected. Each level of screening may have a corresponding score 225. The computation machine 210 may score the text string 125 using the objective function module 215. The objective function module 215 may generate an output score 225 that corresponds to the likelihood of a match between the text string and an employment requirement. The candidate 115 may be the author of the text string. The candidate 115 may be invited to participate in an electronic dialog, such as a chat session with the recruiter 110. Participation in the electronic dialog may involve messaging within a website, such as a website on which the text string resides, short message service (“SMS”), email, instant messaging, PIN messaging, or any other suitable form of chat and/or social media communication.

The computation machine 210 may be used to generate supplemental scores 225 based on the chat session or subsequent chat sessions. The scores 225 may be used to evaluate the likelihood of the match with respect to candidate 115 being a successful remote employee. Scores 225 based on the chat session may be used to select candidate 115 for an oral interview and/or hire the candidate to be a remote employee. In one embodiment, one or more of the score 225 may be based on the presence of identified words in the text string, may be an (e.g., binary) output score 225, and/or may be based on language quality in the text string. The computation machine 210 may be configured to apply a neural network to predict the closeness of the match. The computation machine 210 may be configured to apply a semantic network to predict the closeness of the match.

In one embodiment, the recruiter 110 may perform a new search for tweets that include the text string 125. For example, the selected text string 125 may be “I am looking to work from home with a new employer.” The new search will include tweets that include being “I am looking to work from home with a new employer.” The recruiter 110 may perform further searching by inputting be “I am looking to work from home with a new employer,” or a different phrase. When an appropriate set of tweets is identified, one or more of the candidate's 115 tweets' may be engaged.

The text string 125 may, as indicated above, include a score 225 to indicate the closeness of the text string 125 to one or several terms like, for example, “remote job.” The score 225 may be based on any similarity or closeness metric. For example, the score 225 may be based on a dot-product of the term “remote job” and the text string 125. The score 225 may be a scaled value based on the dot-product.

In some embodiments, the recruiter 110 may execute a search in a social network for communications that includes one or more key terms. For example, the recruiter 110 may search on Twitter for tweets that include the term “remote job.” The search may identify a set of tweets that include the term “remote job.” The recruiter 110 may then execute a semantic network on the term “remote job.” The semantic network may return text string(s) 125 that are semantically related to the term “remote job.”

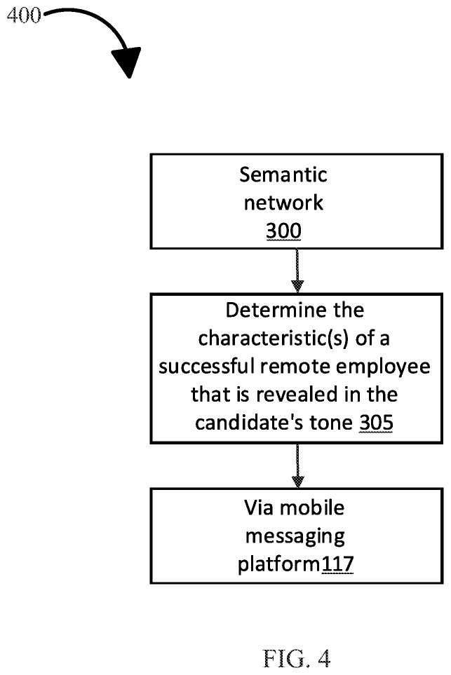

FIG. 4 illustrates a block diagram 400 of the semantic network 300 measuring the characteristic(s) of a successful remote employee that is revealed in the candidate's tone 305 in the mobile messaging platform 117, in accordance with one embodiment of the present disclosure. A semantic network 300, or frame network, is a knowledge base that represents semantic relations between concepts in a network. This is often used as a form of knowledge representation. It is a directed or undirected graph consisting of vertices, which represent concepts, and edges. These represent semantic relations between concepts, mapping, or connecting semantic fields. A semantic network may be instantiated as, for example, a graph database or a concept map.

For example, measuring the characteristic(s) of a successful remote employee that is revealed in the candidate's tone 305 in the mobile messaging platform 117 can include, in one embodiment, characteristic(s) such as 1) organization, 2) self-disciplined, 3) focused, 4) resourceful, 5) intrinsically motivated, 6) assertive, 7) prioritized, 8) independent, and/or 9) calm. Based on the particular words and punctuation used by candidate 115, score(s) 225 (described above) are applied to the corresponding measure. The system 100 alters these score(s) 225 when used in combination with intensifiers and diminishers, like “very” and “little”, and negators, like “not” and “never”. The system 100 also considers emoticons when measuring these characteristics (s). Because different people have different levels of characteristic(s) for being a successful remote employee when communicating, the system 100 calculates normalized measures and trends for each candidate 115. This is later used to contrast and detect uncharacteristic communications. Such uncharacteristic communications can be flagged to the appropriate hiring manager 120.

This process of measuring the characteristic(s) of a successful remote employee that is revealed in the candidate's tone 305 can further be used after candidate 115 gets hired for a remote job. The hiring manager 120 can text the hired candidate 115 to measure the same characteristic(s) described above that is revealed in the candidate's tone 305 after the hired candidate 115 starts working remotely. In an embodiment, the hiring manager 120 repeats this practice daily, weekly, monthly, or at any schedule and at any time of day that the candidate 115 is working.

Anyone or a plurality of hiring manager 120, the recruiter 110, and/or the candidate 110 (herein referred to as the system 100) can include a number of servers configured to support the features and functionality described herein and may have at least one database in communication with servers. In the context of practical implementation, system 100 may include a firewall server, a web server, a file transfer protocol (FTP) server, a simple mail transfer protocol (SMTP) server, and other suitably configured servers. Although depicted as servers being commonly located, system 100 may utilize a distributed server architecture in which a number of servers communicate and operate with one another even though physically located in different locations.

According to an embodiment herein, the present system 100 may use a server to process and store data related to textual interaction between the recruiter and candidate over a mobile messaging platform. As used herein, a “server” refers to a computing device or system configured to perform any number of functions and operations associated with system 100. Alternatively, a “server” may refer to software that performs the processes, methods, and/or techniques described herein. From a hardware perspective, system 100 may utilize any number of commercially available servers, e.g., the IBM AS/400, the IBM RS/6000, the SUN ENTERPRISE 5500, the COMPAQ PROLIANT ML570, and those available from UNISYS, DELL, HEWLETT-PACKARD, or the like. Such servers may run any suitable operating system such as UNIX, LINUX, or WINDOWS, and may employ any suitable number of microprocessor devices, e.g., the family of processors by INTEL or the processor devices commercially available from ADVANCED MICRO DEVICES, IBM, SUN MICROSYSTEMS, or MOTOROLA.

The server processors communicate with system memory (e.g., a suitable amount of random-access memory), and an appropriate amount of storage or “permanent” memory. The permanent memory may include one or more hard disks, floppy disks, CD-ROM, DVD-ROM, magnetic tape, removable media, solid-state memory devices, or combinations thereof. In accordance with known techniques, the operating system programs and any server application programs reside in the permanent memory and portions thereof may be loaded into the system memory during operation. In accordance with the practices of persons skilled in the art of computer programming, the present disclosure is described below with reference to symbolic representations of operations that may be performed by one or more servers associated with system 100. Such operations are sometimes referred to as being computer-executed. It will be appreciated that operations that are symbolically represented include the manipulation by the various microprocessor devices of electrical signals representing data bits at memory locations in the system memory, as well as other processing of signals. The memory locations where data bits are maintained are physical locations that have particular electrical, magnetic, optical, or organic properties corresponding to the data bits.

When implemented in software, various elements of the present disclosure are essentially the code segments that perform the various tasks. The program or code segments can be stored in a processor-readable medium or transmitted by a computer data signal embodied in a carrier wave over a transmission medium or communication path. The “processor-readable medium” or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

As used herein, a “computing device” is any device or combination of devices capable of providing system information to an end-user of system 100. For example, a computing device may be a personal computer, a television monitor, an Internet-ready console, a wireless telephone, a personal digital assistant (PDA), a home appliance, a component in an automobile, or the like. Computing devices are preferably configured in conventional ways known to those skilled in the art. In addition, computing devices may be suitably configured to function in accordance with certain aspects of the present disclosure, as described in more detail herein. For the sake of clarity and brevity, conventional and well-known aspects of computing devices are not described in detail herein.

In the preferred embodiment, system 100 is capable of supporting a plurality of different computing devices simultaneously. In practice, a single end-user may utilize a plurality of computing devices in conjunction with system 100. For example, a person may use a desktop computer at the office, a portable laptop computer while traveling, a cellular telephone, and a PDA. System 100 is capable of supporting the integrated use of such multiple devices in a manner that enables the user to access and utilize the features of the present disclosure via the different computing devices. In addition, system 100 is preferably configured to support a plurality of end-users, each of which may have personal data or individual preferences and display settings associated therewith. Such user-specific characteristic(s) may be suitably stored in the database and managed by system 100.

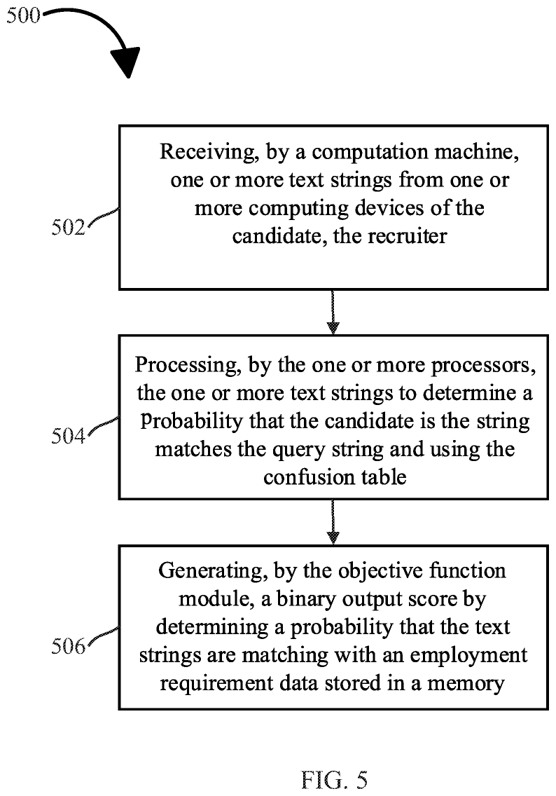

FIG. 5 illustrates a flowchart 500 of the method for assessing a candidate for identifying a successful remote employee based on a textual interaction between a recruiter and the candidate over a mobile messaging platform, in accordance with an alternative embodiment of the present disclosure. The method includes a step 502 of receiving, by a computation machine, one or more text strings from one or more computing devices of the candidate, and the recruiter. The computation machine includes one or more processors and an objective function module. The method includes a step 504 of processing, by the one or more processors, the one or more text strings for determining a probability of a match between the text strings and an employment requirement data. The method includes a step 506 of generating, by the objective function module, an (e.g., binary) output score by determining the probability that the text strings are matching with the employment requirement data stored in a memory. The objective function module identifies the successful remote employee based on the (e.g., binary) output score. In an embodiment, the objective function module is a function in the computation machine that generates the (e.g., binary) output score(s) based on the text strings that correspond to the probability of a match between the text strings and the employment requirement data.

In an embodiment, the computation machine is configured to apply a semantic network to predict a closeness of the matching between the text strings and the employment requirement data. In an embodiment, the semantic network measures one or more characteristics of the successful remote employee that is revealed in the candidate's tone in the mobile messaging platform. In an embodiment, the semantic network is a knowledge base that represents semantic relations between one or more concepts.

In an embodiment, the computation machine is configured to apply a neural network to predict the closeness of the match between the text strings and the employment requirement data. In an embodiment, the recruiter executes a search in a social network platform for communications that includes one or more key terms by using one or more computing devices.

Accordingly, one advantage of the present disclosure is that the computation machine scores text string(s) using the objective function module. The objective function module may generate an output score that corresponds to the likelihood of a match between the text string and an employment requirement.

Accordingly, one advantage of the present disclosure is that the semantic network measures the characteristic(s) of a successful remote employee that is revealed in the candidate's tone in the mobile messaging platform. Based on the particular words and the measuring of the characteristic(s) of a successful remote employee, score(s) are applied. Measuring the characteristic(s) of the successful remote employee that is revealed in the candidate's tone in the mobile messaging platform can further be used after the candidate gets hired for a remote job. The hiring manager can text the hired candidate to measure the characteristic(s) described above revealed in the candidate's response after the hired candidate starts working remotely.

Unless otherwise defined, all terms (including technical and scientific terms) used in this disclosure have the same meaning as commonly understood by one of ordinary skill in the art to which this disclosure belongs. It is to be understood that the phrases or terms employed of the present disclosure are for description and not of limitation. As will be appreciated by one of the skills in the art, the present disclosure may be embodied as a device, system, method, or computer program product. Further, the present disclosure may take the form of a computer program product on a computer-readable storage medium having computer-usable program code embodied in the medium. The present systems and methods have been described above with reference to specific examples. However, other embodiments and examples than the above description are equally possible within the scope of the present disclosure. The scope of the disclosure may only be limited by the appended patent claims. Even though modifications and changes may be suggested by the persons skilled in the art, it is the intention of the inventors and applicants to embody within the patent warranted heron all the changes and modifications as reasonably and properly come within the scope of the contribution the inventors and applicants to the art. The scope of the embodiments of the present disclosure is ascertained with the claims to be submitted at the time of filing the complete specification.

What is claimed is:

1. A method for assessing a candidate for identifying a successful remote employee based on a textual interaction between a recruiter and the candidate over a mobile messaging platform, the method comprising:
receiving, by a computation machine, one or more text strings from one or more computing devices of the candidate and the recruiter, wherein the computation machine comprises one or more processors, and an objective function module;
processing, by the one or more processors, the one or more text strings for determining a probability that the candidate matches the query string using the computation machine;
generating, by the objective function module, an output score by determining a probability that the text strings match with an employment requirement data stored in a memory, wherein the objective function module identifies the successful remote employee based on the output score.

2. The method according to claim 1, wherein the computation machine is configured to apply a semantic network to predict a closeness of the match between the text strings and the employment requirement data.

3. The method according to claim 2, wherein the semantic network measures one or more characteristics of the successful remote employee.

4. The method according to claim 1, wherein the objective function module is a function in the computation machine that generates the output score based on the text strings that correspond to the probability of a match between the text strings and the employment requirement data.

5. The method according to claim 1, wherein the computation machine is configured to apply a neural network to predict a closeness of the match between the text strings and the employment requirement data.

6. The method according to claim 1, wherein the recruiter executes a search in a social network platform for communications that includes one or more key terms by using the one or more computing devices.

7. The method according to claim 1, wherein the semantic network is a knowledge base that represents semantic relations between one or more concepts.

8. A system to assess a candidate to identify a successful remote employee based on a textual interaction between a recruiter and the candidate over a mobile messaging platform, the system comprising:
a computation machine to receive one or more text strings from one or more computing devices of the candidate and the recruiter, wherein the computation machine comprises:
one or more processors to process the one or more text strings to determine a probability that the candidate is matches the query string and using the computation machine; and
an objective function module to generate an output score by determining a probability that the text strings match an employment requirement data stored in a memory, wherein the objective function module identifies the successful remote employee based on the output score.

9. The system according to claim 8, wherein the computation machine is configured to apply a semantic network to predict a closeness of the matching between the text strings and the employment requirement data.

10. The system according to claim 9, wherein the semantic network measures one or more characteristics of the successful remote employee.

11. The system according to claim 8, wherein the objective function module is a function in the computation machine that generates the output score based on the text strings that correspond to the probability of a match between the text strings and the employment requirement data.

12. The system according to claim 8, wherein the computation machine is configured to apply a neural network to predict a closeness of the match between the text strings and the employment requirement data.

13. The system according to claim 8, wherein the recruiter executes a search in a social network platform for communications that includes one or more key terms by using the one or more computing devices.

14. The system according to claim 8, wherein the semantic network is a knowledge base that represents semantic relations between one or more concepts.

15. A non-transitory computer-readable storage medium storing executable instructions for assessing a candidate for identifying a successful remote employee based on a textual interaction between a recruiter and the candidate over a mobile messaging platform that, as a result of being executed by a memory and one or more processors of a computation machine, cause the computation machine to at least:
receive, by the computation machine, one or more text strings from one or more computing devices of the candidate and the recruiter;
process, by the one or more processors, the one or more text strings to determine a probability that the candidate matches the query string using computation machine;
generate, by an objective function module, an output score by determining a probability that the text strings are matching with an employment requirement data stored in the memory, wherein the objective function module identifies the successful remote employee based on the output score.

16. The non-transitory computer-readable medium according to claim 15, wherein the computation machine is configured to apply a semantic network to predict a closeness of the matching between the text strings and the employment requirement data.

17. The non-transitory computer-readable medium according to claim 16, wherein the semantic network measures one or more characteristics of the successful remote employee.

18. The non-transitory computer-readable medium according to claim 15, wherein the objective function module is a function in the computation machine that generates the output score based on the text strings that correspond to the probability of a match between the text strings and the employment requirement data.

19. The non-transitory computer-readable medium according to claim 15, wherein the computation machine is configured to apply a neural network to predict a closeness of the match between the text strings and the employment requirement data.

20. The non-transitory computer-readable medium according to claim 15, wherein the recruiter executes a search in a social network platform for communications that includes one or more key terms by using the one or more computing devices.
